(19) United States
(12) Patent Application Publication
(10) Pub. No.: US 2008/0049313 A1
(43) Pub. Date: Feb. 28, 2008

(54) ILLUMINATION OPTICS FOR AN OPTICAL OBSERVATION DEVICE

(75) Inventors: Michael Brehm, Sulzbach-Laufen (DE); Werner Kleinschmidt, Adelebsen (DE); Jan Thirase, Goettingen (DE)

Correspondence Address: Gerald H. Kiel, Esq.;REED SMITH LLP, 599 Lexington Avenue, New York, NY, 10022-7650, US

(73) Assignee: Carl Zeiss Microlmaging GmbH

(21) Appl. No.: 11/844,441

(22) Filed: Aug. 24, 2007

(30) Foreign Application Priority Data
Aug. 25, 2006 (DE) 10 2006 039 976.5

(51) Int. Cl. G02B 21/06

(52) U.S. Cl. 359/387; 359/385

(57) ABSTRACT

The invention is directed to illumination optics for an optical device for observing a sample, particularly for TIRF microscopy (Total Internal Reflection Fluorescence Microscopy), wherein the sample is positioned on the side of a carrier glass remote of the illumination optics and the illumination light exiting from the illumination optics is shaped into an illumination beam bundle which encloses an angle not equal to 90° with the normal to the surface of the carrier glass. According to the invention, the illumination optics of the type mentioned above comprise at least two optically active elements which influence the shape and direction of the illumination beam bundle and which are arranged outside of the detection beam path that guides light coming from the sample to a detector. The optically active elements are preferably constructed as annular lenses and are arranged concentrically around the detection beam path.

### CROSS-REFERENCE TO RELATED APPLICATION

This application claims priority of German Application 10 2006 039 976.5, filed Aug. 25, 2006, the complete disclosure of which is hereby incorporated by reference.

### BACKGROUND OF THE INVENTION

a) Field of the Invention

The invention is directed to illumination optics for an optical device for observing a sample, particularly for TIRF microscopy (Total Internal Reflection Fluorescence Microscopy), wherein the sample is positioned on the side of a carrier glass remote of the illumination optics and the illumination light exiting from the illumination optics is shaped into an illumination beam bundle which encloses an angle not equal to 90° with the normal to the surface of the carrier glass.

b) Description of the Related Art

The principle of TIRF microscopy is known, per se, from the prior art. Light coming through the carrier glass is totally reflected at the interface between the carrier glass and the sample.

A condition for this is that the refractive index of the sample material is less than the refractive index of the glass of which the carrier glass is made. Proceeding from the zone of total reflection and extending into the sample material is an illumination field which decays exponentially as the depth increases and which is referred to as an evanescent illumination field.

With this type of illumination, it is possible to provide illumination which is well delimited with respect to depth in the sample and can be used in an advantageous manner to excite only the fluorescent dyes in the immediate vicinity of the carrier glass inside the sample.

The depth to which the evanescent illumination field penetrates into the sample depends on the given angle β, provided that the angle β satisfies the conditions of total reflection.

By angle β is meant within the framework of the invention described hereinafter the angle enclosing the illumination beam bundle incident on the interface between the carrier glass and sample with the normal on the carrier glass and therefore, for example, with the optical axis of a microscope objective. In general, the direction in which the optical axis extends is also the Z-direction of a coordinate system X, Y, Z so that the carrier glass then lies in a plane defined by coordinates X, Y.

By varying the angle β, the depth to which the illumination field penetrates into the sample can change.

Arrangements for incident darkfield illumination in microscopes in which a similar illumination channel is used for darkfield illumination are known. TIRF microscopy is not possible in this arrangement because the illumination bundle suffers from such large aberrations that total reflection does not occur for all beams. One example of this is the Epiplan-Neofluar 100x/1.3 oil HD 442483-0000-000 by Carl Zeiss, Germany. A further disadvantage in these arrangements consists in that it is only possible to illuminate, and therefore observe, sample fields of a relatively small size. Further, the aberrations of the illumination system are so large that there is not even any question of an angle β because a whole angular range occurs.

DE 196 30 322 A1 describes an optical darkfield incident illumination system by which excitation light can be imaged on the sample. It has the disadvantages mentioned above.

### OBJECT AND SUMMARY OF THE INVENTION

Proceeding from this prior art, it is the primary object of the invention to provide illumination optics of the type mentioned above which make it possible to observe larger fields in the sample and also to expand the available range of variation of the angle β.

According to the invention, the illumination optics of the type mentioned above comprise at least two optically active elements which influence the shape and direction of the beam bundle and which are arranged outside of the detection beam path that guides light coming from the sample to a detector. These optically active elements are preferably annular and are arranged concentrically around the detection beam path.

For example, the optically active elements can be constructed as annular lenses which have spherically or aspherically curved light entrance surfaces and light exit surfaces arranged concentrically around the detection beam path.

An immersion liquid is provided between the light exit surface of the final lens (considered in direction of the illumination beam path), which is also designated as front lens within the framework of the present invention, and the carrier glass. The glass from which the front lens is made should have a refractive index nₑ that diverges from the refractive index nₑ of the immersion liquid by no more than 0.05 and whose dispersion vₑ diverges from the dispersion vₑ of the immersion liquid by no more than 20.

In a particularly advantageous manner, an embodiment form of the illumination optics according to the invention comprises four annular lenses.

Alternatively, it is conceivable and also lies within the framework of the invention when the optically active elements are constructed as annular mirrors with spherically or aspherically curved mirror surfaces arranged concentrically around the detection beam path.

In this case, at least one of the mirrors can be constructed as a second-surface or rear-surface mirror in which the light to be reflected first penetrates a carrier layer, is reflected at a mirror layer arranged on the back of the carrier layer, and exits through the carrier material in the reflected direction.

In an embodiment form of the illumination optics according to the invention with mirrors arranged concentrically around the detection beam path, the final mirror (considered in direction of the illumination beam path) can be constructed, for example, as a rear-surface mirror.

Illumination optics in which annular mirrors are provided in its illumination beam path in addition to annular lenses as optically active elements are also conceivable and lie within the framework of the invention.

In a particularly advantageous manner, the optically active elements in the illumination optics according to the invention are designed for total focal lengths in the range of 1 mm to 50 mm.

Further, the optically active elements should be constructed in such a way that the illumination beam path exits from the front lens as a parallel light bundle and all of the beam components of the parallel light bundle strike the interface between the carrier glass and sample at the same angle β which prevents nonparallel beam components which differ with respect to wavelength as well as nonparallel beam components due to aberrations.

The invention is also directed to the use of the described illumination optics in microscopes with an incident illumination system and in microscopes with a transmitted light illumination system.

The invention will be described more fully in the following with reference to an embodiment example.

### BRIEF DESCRIPTION OF THE DRAWINGS

In the drawings:

FIG. 1 illustrates illumination optics in accordance with the invention in diagrammatic form; and

FIG. 2 illustrates an enlarged view of area A of FIG. 1.

### DESCRIPTION OF THE PREFERRED EMBODIMENTS

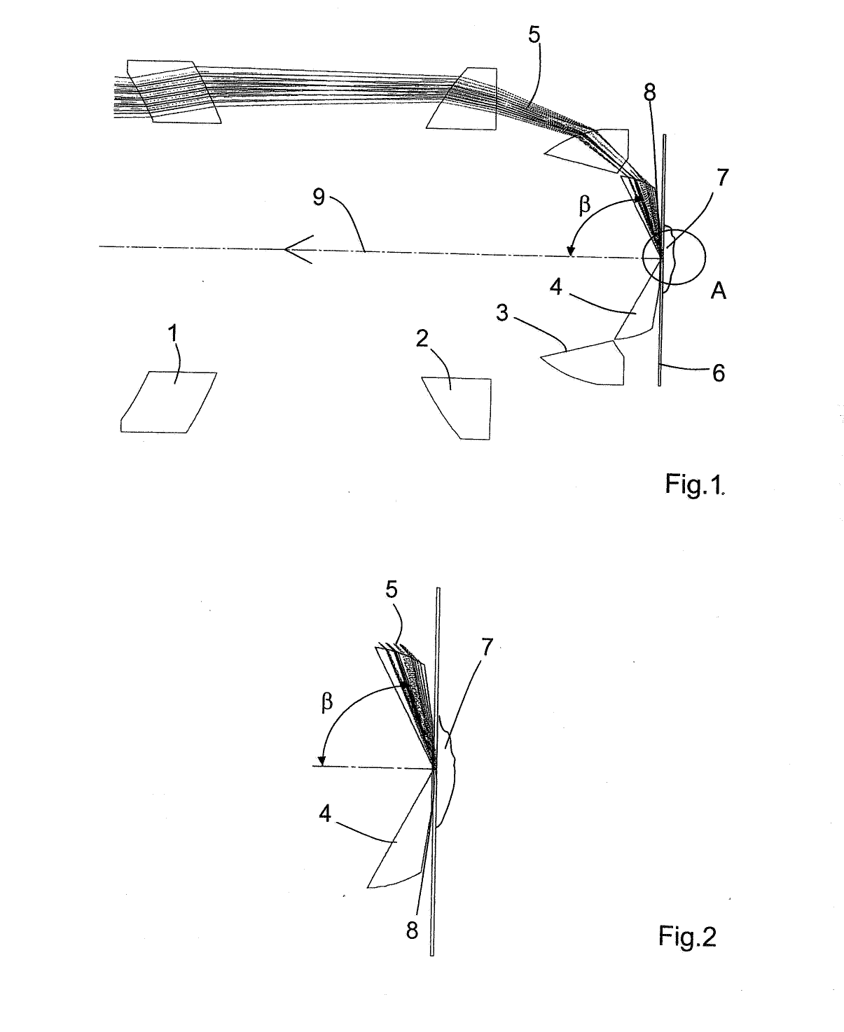

FIG. 1 shows illumination optics, according to the invention, which comprise four annular lenses 1 to 4. Lens 4 forms the front lens from which the illumination beam bundle 5 exits and strikes the interface between a carrier glass 6 and the sample 7 at an angle β which satisfies the condition of total reflection. An immersion liquid 8 is provided between the front lens 4 and the carrier glass 6.

The light coming from the sample 7 travels in a detection beam path 9 in the cut out center of the annular lenses 1 to 4 and reaches a detection device, not shown.

Lenses 1 to 4 have the radii r, thicknesses d, distances a in mm, refractive indexes nₑ at wavelength 546 nm, Abbe numbers vₑ, and free diameters Frd indicated in the following table. Contrary to the positive distances between the lenses which are otherwise only possible and conventional, negative distances or the distance 0 mm are also possible. This is easy to understand: if the drilled lens were filled to form a normal lens, the lenses would penetrate one another because of the very presence of this negative distance of the lens vertexes.

| | | | | | Refractive | Abbe | |
|---|---|---|---|---|---|---|---|
| Lens | Surface | Radius r | Thickness d | Distance a | index nₑ | number νₑ | Frd |
| 1 | 2 | −25.0000 | 5.28456 | | 1.52458 | 59.22 | 28 |
| | 3 | −28.1068 | | | | | |
| | | | | 12.4776 | | | |
| 2 | 4 | 22.7704 | 8.12534 | | 1.48914 | 70.23 | 30 |
| | 5 | −3033.99 | | | | | |
| | | | | 0.0000 | | | |
| 3 | 6 | 10.4645 | 8.0000 | | 1.48914 | 70.23 | 20.6 |
| | 7 | 12.9410 | | | | | 15.0 |
| | | | | −5.0000 | | | |
| 4 | 8 | 6.6167 | | 10.5253 | 1.52458 | 59.22 | 13.2334 |
| | 9 | plane | | | | | |

NK5 and NFK5 are possible types of glass that may be used. The carrier glass 6 is planar and has a thickness of 0.17 mm.

Standard immersion oil with a refractive index nₑ=1.518 and a dispersion vₑ=47.37 is advantageously used as immersion liquid 8.

The angle β is varied by changing the distance from the focus point to the optical axis. For example, when the distance between the focus point and the optical axis is 12.5 mm, angle β is 82.5°; when this distance is 12.17 mm, angle β is 74.1°, etc.

FIG. 2 shows a larger view of the area A indicated in FIG. 1. It can be seen that the illumination beam path 5 exits from the front lens 4 as a parallel light bundle and is directed through the immersion liquid 8 and the carrier glass 6 to the interface between the side of the carrier glass 6 remote of the front lens 4 and the sample 7.

Fields with a diameter of about 580 μm can be observed on the sample with this construction of the illumination optics according to the invention. This results in a significant advantage over the prior art because previously only fields of about 110 μm diameter could be observed.

This advantage is achieved substantially because separate illumination optics are used which can have a different focal length than the detection optics.

Another advantage is the possibility of reducing the penetration depth because angles β up to 81.2° can be realized with the illumination optics according to the invention, which corresponds to a numerical aperture of 1.50 when the refractive index of the immersion oil is 1.518. Because of the available long focal length by which the light source is imaged in the sample, it possible to vary the illumination angle or angle β substantially more accurately than in the prior art in which the illumination of the sample is carried out through a microscope objective.

Another substantial advantage consists in that the autofluorescence of the material from which the optical elements of the microscope objective are made in the prior art need not be taken into account because these elements are no longer penetrated by the illumination light (which corresponds to the excitation light in fluorescence microscopy).

Therefore, the entire optical system of these illumination optics can be optimized specifically to the shorter wavelengths of fluorescence excitation radiation, and it is now only necessary to correct the outside pupil area for a light bundle with a small diameter so that the optical system can be designed in an uncomplicated manner.

While the foregoing description and drawings represent the present invention, it will be obvious to those skilled in the art that various changes may be made therein without departing from the true spirit and scope of the present invention.

### REFERENCE NUMBERS

1, 2, 3 lenses
4 front lens
5 illumination beam bundle
6 carrier glass
7 sample
8 immersion liquid
9 detection beam path
β angle

What is claimed is:

1. Illumination optics for an optical device for observing a sample, particularly for TIRF microscopy (Total Internal Reflection Fluorescence Microscopy), wherein a sample is arranged on a side of a carrier glass remote of the illumination optics and illumination light exiting from the illumination optics is shaped into an illumination beam bundle which encloses an angle not equal to 90° with the normal to the surface of the carrier glass, comprising:
at least two optically active elements which influence the shape and direction of the illumination beam bundle and which are arranged outside of the detection beam path that guides light coming from the sample to a detector.

2. Illumination optics according to claim 1, wherein the optical elements are annular and are arranged concentrically around the detection beam path.

3. Illumination optics according to claim 1, wherein the optically active elements are constructed as annular lenses with light entrance surfaces and light exit surfaces arranged concentrically around the detection beam path.

4. Illumination optics according to claim 3, wherein an immersion liquid is provided between the light exit surface of the final lens in direction of the illumination beam path, i.e., the front lens, and the carrier glass.

5. Illumination optics according to claim 4, wherein the glass from which the front lens is made has a refractive index nₑ that diverges from the refractive index nₑ of immersion liquid by no more than 0.05 and whose dispersion vₑ diverges from the dispersion vₑ of the immersion liquid by no more than 20.

6. Illumination optics according to claim 5, comprising four lenses having the radii r, thicknesses d, distances a in mm, refractive indexes nₑ at wavelength 546 nm, Abbe numbers vₑ, and free diameters Frd indicated in the following table:

| | | | | | Refractive | Abbe | |
|---|---|---|---|---|---|---|---|
| Lens | Surface | Radius r | Thickness d | Distance a | index nₑ | number νₑ | Frd |
| 1 | 2 | −25.0000 | 5.28456 | | 1.52458 | 59.22 | 28 |
| | 3 | −28.1068 | | | | | |
| | | | | 12.4776 | | | |
| 2 | 4 | 22.7704 | 8.12534 | | 1.48914 | 70.23 | 30 |
| | 5 | −3033.99 | | | | | |
| | | | | 0.0000 | | | |
| 3 | 6 | 10.4645 | 8.0000 | | 1.48914 | 70.23 | 20.6 |
| | 7 | 12.9410 | | | | | 15.0 |
| | | | | −5.0000 | | | |
| 4 | 8 | 6.6167 | | 10.5253 | 1.52458 | 59.22 | 13.2334 |
| | 9 | plane | | | | | |

7. Illumination optics according to claim 6, wherein the illumination beam path exits from the front lens as a parallel light bundle, wherein all of the beam components of the parallel light bundle which differ with respect to wavelength strike the interface between the carrier glass and sample at the same reflection angle β.

8. Illumination optics according to claim 1, wherein the optical elements are constructed as annular mirrors with mirror surfaces arranged concentrically around the detection beam path.

9. Illumination optics according to claim 8, wherein at least one of the mirrors is constructed as a rear-surface mirror.

10. Illumination optics according to claim 8, wherein the final mirror before the carrier glass considered in direction of the illumination beam path, i.e., the front mirror, is constructed as a rear-surface mirror, and an immersion liquid is provided between the front mirror and the carrier glass.

11. Illumination optics according to claim 1, wherein optical elements which are constructed as annular lenses and as annular mirrors are provided.

12. Illumination optics according to claim 1, with a focal length in the range of 1 mm to 50 mm.

13. Illumination optics according to claim 1, wherein the angle β can be up to 81.2°, which corresponds to a numerical aperture of 1.50 when the refractive index nₑ of the immersion media is 1.518.

14. A method of using illumination optics according to claim 1 in a microscope with an incident light illumination system.

15. A method of using illumination optics according to claim 1 in a microscope with a transmitted light illumination system
